(19) United States
(12) Patent Application Publication
(10) Pub. No.: US 2025/0173169 A1
(43) Pub. Date: May 29, 2025

(54) DEVICE AND METHODS FOR PROVIDING ACTIONABLE SUGGESTION

(71) Applicant: Samsung Electronics Co., Ltd., Suwon-si (KR)

(72) Inventors: Naresh PURRE, Bengaluru (IN); Debi Prasanna MOHANTY, Bengaluru (IN); Sukumar MOHARANA, Bengaluru (IN); Vanraj VALA, Bengaluru (IN); Gopi RAMENA, Bengaluru (IN); Kamal JAKHAR, Bengaluru (IN)

(21) Appl. No.: 18/889,978

(22) Filed: Sep. 19, 2024

Related U.S. Application Data
(63) Continuation of application No. PCT/KR2024/013086, filed on Aug. 30, 2024.

(30) Foreign Application Priority Data
Nov. 28, 2023 (IN) 202341080739

(51) Int. Cl. G06F 9/451; G06F 3/0484

(52) U.S. Cl. CPC G06F 9/451; G06F 3/0484

(57) ABSTRACT

An electronic device and method performed by the electronic device for suggesting at least one are provided. The method includes detecting a user selection of a first modality in a display of the electronic device and at least one second modality present in vicinity to the first modality, deriving at least one pair of the first modality and at least one second modality by correlating the first modality and the at least one second modality, and providing a suggestion in a form of a user-operable interface based on the derived at least one pair. A user operation on the suggestion initiates execution of the at least one action on the first modality via an application.

### CROSS-REFERENCE TO RELATED APPLICATION(S)

This application is a continuation application, claiming priority under § 365 (c), of an International application No. PCT/KR2024/013086, filed on Aug. 30, 2024, which is based on and claims the benefit of an Indian Patent Application number 202341080739, filed on Nov. 28, 2023, in the Indian Intellectual Property Office, the disclosure of which is incorporated by reference herein in its entirety.

### TECHNICAL FIELD

The disclosure relates to managing interaction with an electronic device. More particularly, the disclosure relates to using multimodal communication for suggesting at least one action to a user of an electronic device.

### BACKGROUND ART

In general, an electronic device shows scenic images with text that refers to several entities, which can be actionable entities. Detection of such entities can be difficult using only the input images. As there is limited textual context in the image, it may not be possible to detect and disambiguate the entities.

FIG. 1 depicts s system referred to as named-entity recognition (NER), according to the related art. NER is also referred to as entity identification, entity chunking, and entity extraction, and is a subtask of information extraction that seeks to locate and classify named entities mentioned in unstructured text into pre-defined categories such as person names, organizations, locations, medical codes, time expressions, quantities, monetary values, percentages, etc. as the standard entities.

In this example scenario, an image showing named entities is detected in the textual content. The system of the related art has been structured as taking an unannotated block of text, such as “Jim bought 300 shares of Acme Corp. in 2006” and producing an annotated block of text that highlights the names of entities: “[Jim] Person bought 300 shares of [Acme Corp.] Organization in Time.” A person name comprising of one token, a two-token company name, and a temporal expression is detected and classified. Detection of named entities on textual inputs requires textual context to detect the entities correctly. In the case of visual inputs, for example, images that contain some text, it is difficult to detect entities due to a lack of textual context.

FIG. 2 depicts a method 200 referred to as Multimodal Named Entity Recognition, according to the related art. Multimodal Named Entity Recognition recognizes the entities in image caption text using associated image understanding. In this example scenario, a poster comprises a location entity, but the contextual information in the textual content present in the poster is not enough to detect or recognize the location entity with the help of NER solutions of the related art. A user is disappointed for not being able to find a relevant entity after extracting text from an input image.

At operation 202, the textual content present in the input image is extracted. At operation 204, the method of Named Entity Recognition recognizes the entities from the extracted text. At operation 206, the user is disappointed to detect an irrelevant entity after extracting text from the input image.

The methods of the related art do not detect entities in scene text. Those methods are limited to detecting limited entities such as person names, organizations, locations, medical codes, time expressions, quantities, monetary values, percentages, etc. The methods of the related art require long portions of text to perform well to detect meaning, suffer from entity disambiguation, and cannot discover new types of entities due to a single modality trained on the predefined type that does not take care of the other modality to make a new entity. Therefore, the methods of the related art do not work well on scene text or small text scenarios. For example, ‘June’ is a month, name, or location that the method of the related art cannot identify whether not enough text is present about it. Similarly, the knowledge graph (KG) is limited in vocabulary. For example, DBpedia KG has only 764,000 persons, including entity disambiguation.

FIGS. 3A and 3B depicts a method according to the related art. In the related art, when a user does a long press on any text present in a display of an electronic device, the device provides options such as Call, Mail, Web, Map, and Add event along with Cut, Copy, and Select all upon user selection of text using the touchpoints, such as, gallery, screenshot, smart capture, camera, internet, keyboard and so on.

FIG. 4 describes a method according to the related art. In the method of FIG. 4, when a user does a “long press” or taps the “T Button” on any text present in a display of an electronic device, the device provides options such as Email, Copy, Select All, and Share options based on the selected text.

Nowadays, it is common to send messages or any kind of information in the form of images. The image indicates all the information regarding that specific event. For example, birthday or wedding invitations, any kind of event such as a webinar, conference, workshop, and so on. Users want to use the contents that are present in the image. However, there is no specific method or device to allow the natural text selection of a long press in the images, which provides an actionable suggestion and initiates the execution of an action immediately. Thus, it is desirable to have a solution for a consistent experience of text selection in the media across the electronic device.

Currently, there are a lot of devices available on the market that allow text selection in the images but those devices do not identify the correct entity. For example, the device does not identify whether Devanahalli is a place, person name, or other entity in the poster, and due to this reason, the device shows the Translate action or Copy text on the screen. Although the map icon is present beside the textual information, which indicates it as a location, the device cannot extract the location details.

In an example scenario, wherein a poster is present, although a WhatsApp icon is present beside the textual information (e.g., a mobile number), which indicates a WhatsApp call, the device does not identify this as a WhatsApp call and shows a normal voice call action on the screen. The call is initiated in the default voice call application.

The above information is presented as background information only to assist with an understanding of the disclosure. No determination has been made, and no assertion is made, as to whether any of the above might be applicable as prior art with regard to the disclosure.

### DISCLOSURE

### Technical Solution

Aspects of the disclosure are to address at least the above-mentioned problems and/or disadvantages and to provide at least the advantages described below. Accordingly, an aspect of the disclosure is to provide a device and methods for suggesting at least one action in an electronic device using different modalities, wherein the modalities are selected from an image or a video frame from the display of the electronic device.

Another aspect of the disclosure is to provide a device and methods for detecting a user selection of a first modality in a display of the electronic device.

Another aspect of the disclosure is to provide a device and methods for detecting at least one second modality present in a vicinity of the first modality using a layout learning model.

Another aspect of the disclosure is to provide a device and methods for deriving at least one entity by correlating the first modality and the second modality, wherein the first and second modality comprises at least one of one or more textual elements and one or more non-textual elements.

Another aspect of the disclosure is to provide a device and methods for providing a display of at least one action using a user-operable interface, on at least one entity via an application, wherein the displayed at least one action initiates execution of at least one action via the application on the user performing an operation.

Additional aspects will be set forth in part in the description which follows and, in part, will be apparent from the description, or may be learned by practice of the presented embodiments.

In accordance with an aspect of the disclosure, a method performed by an electronic device for suggesting at least one action are provided. The method includes detecting, by the electronic device, a user selection of a first modality from a display of the electronic device, detecting, by the electronic device, at least one second modality present in the vicinity of the first modality, deriving, by the electronic device, at least one entity by correlating the first modality and the second modality, and providing, by the electronic device, a suggestion in a form of a user-operable interface based on the derived at least one pair. A user operation on the suggestion initiates the execution of at least one action on the first modality via an application.

In accordance with another aspect of the disclosure, an electronic device for suggesting at least one action is provided. The electronic device includes a display, memory storing one or more computer programs, and one or more processors communicatively coupled to the display and memory. The one or more computer programs include computer-executable instructions that, when executed by the one or more processors individually or collectively, cause the electronic device to detect the user selection of a first modality from the display, detect at least one second modality present in the vicinity of the first modality, derive at least one entity by correlating the first modality and the second modality, and provide a suggestion in a form of a user-operable interface based on the derived at least one pair. A user operation on the suggestion initiates the execution of at least one action on the first modality via the application.

In accordance with another aspect of the disclosure, one or more non-transitory computer-readable storage media storing one or more computer programs including computer-executable instructions that, when executed by one or more processors of an electronic device individually or collectively, cause the electronic device to perform operations for suggesting at least one action is provided. The operations include detecting, by the electronic device, a user selection of a first modality in a display of the electronic device, detecting, by the electronic device, at least one second modality present in vicinity to the first modality, deriving, by the electronic device, at least one pair of the first modality and the at least one second modality by correlating the first modality and the at least one second modality, and providing, by the electronic device, a suggestion in a form of a user operable interface, based on the derived at least one pair. A user operation on the suggestion initiates execution of the at least one action on the first modality via an application.

Other aspects, advantages and salient features of the disclosure will become apparent to those skilled in the art from the following detailed description, which, taken in conjunction with the annexed drawings, discloses various embodiments of the disclosure.

### DESCRIPTION OF DRAWINGS

The above and other aspects, features, and advantages of certain embodiments of the disclosure will be more apparent from the following description taken in conjunction with the accompanying drawings, in which:

FIG. 1 depicts a system referred to as Named-Entity Recognition (NER), according to the related art;

FIG. 2 depicts a method referred to as Multimodal Named Entity Recognition, according to the related art;

FIGS. 3A, 3B, and 4 depict drawbacks associated with methods, according to the related art;

FIG. 5 depicts an electronic device for suggesting at least one action in the electronic device using different modalities, according to an embodiment of the disclosure;

FIG. 6 is a flowchart illustrating a method for suggesting at least one action in the electronic device, according to an embodiment of the disclosure;

FIG. 7 depicts an overall architecture of a multi modal recommendation, according to an embodiment of the disclosure;

FIG. 8 is a flow diagram depicting an overall pipeline of the multi modal recommendation, according to an embodiment of the disclosure;

FIG. 9 depicts a block representation for selecting the different modalities form the media, according to an embodiment of the disclosure;

FIG. 10 is an example diagram depicting the selection of the visual modality from the entire media frame in connection with Table 1000, according to an embodiment of the disclosure;

FIG. 11 depicts a method for visual modality detection, according to an embodiment of the disclosure;

FIG. 12 depicts a system flow representation for suggesting at least one action in the electronic device, according to an embodiment of the disclosure;

FIG. 13 depicts a method for performing dynamic updation, according to an embodiment of the disclosure;

FIGS. 14A and 14B is an example use case for a multimodal ambiguity, according to various embodiments of the disclosure;

FIGS. 15A and 15B is an example use case for a caller application ambiguity, according to various embodiments of the disclosure;

FIGS. 16A and 16B is an example use case for a new entity recognition, according to various embodiments of the disclosure; and

FIGS. 17A and 17B is an example use case for an entity correctness, according to various embodiments of the disclosure.

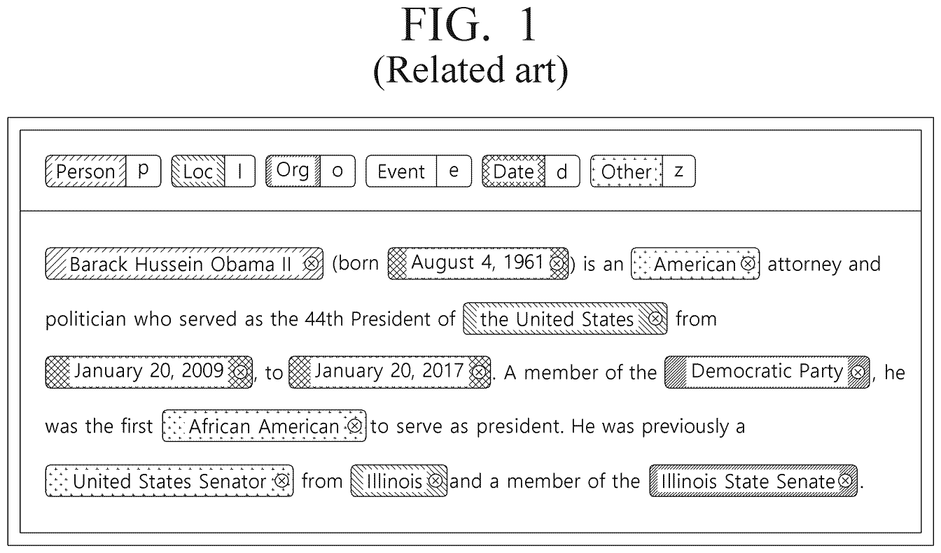

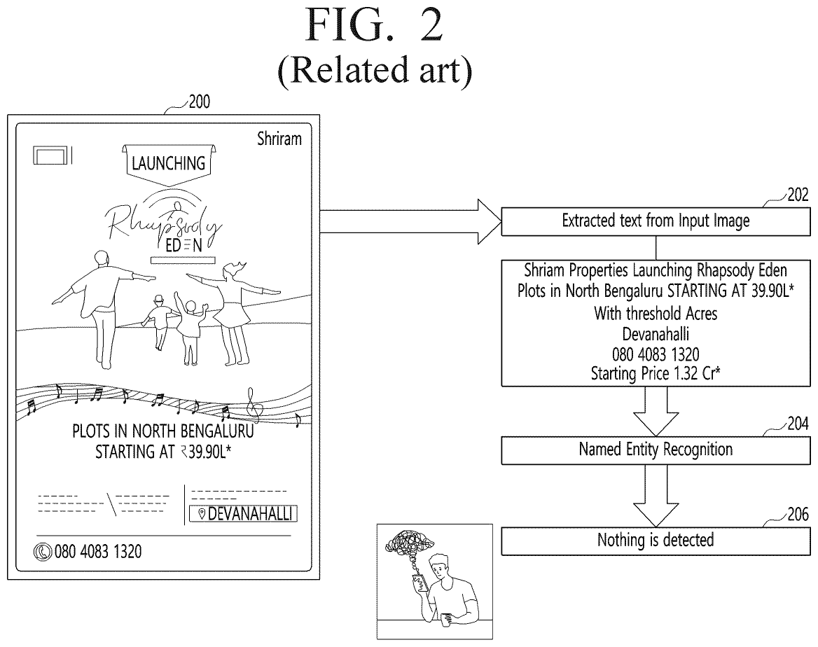

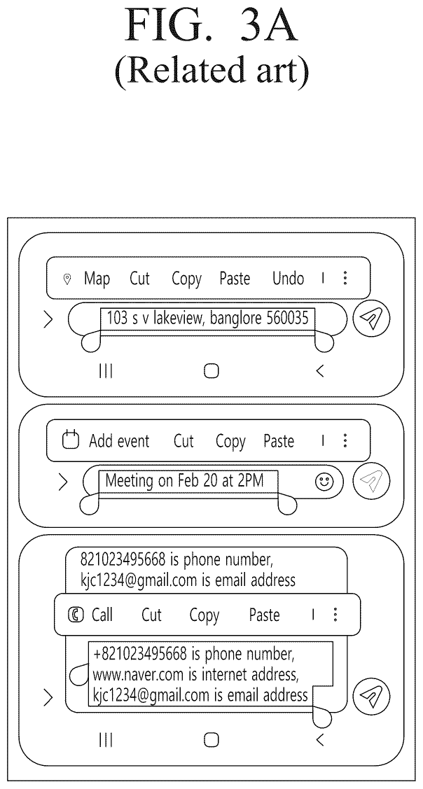

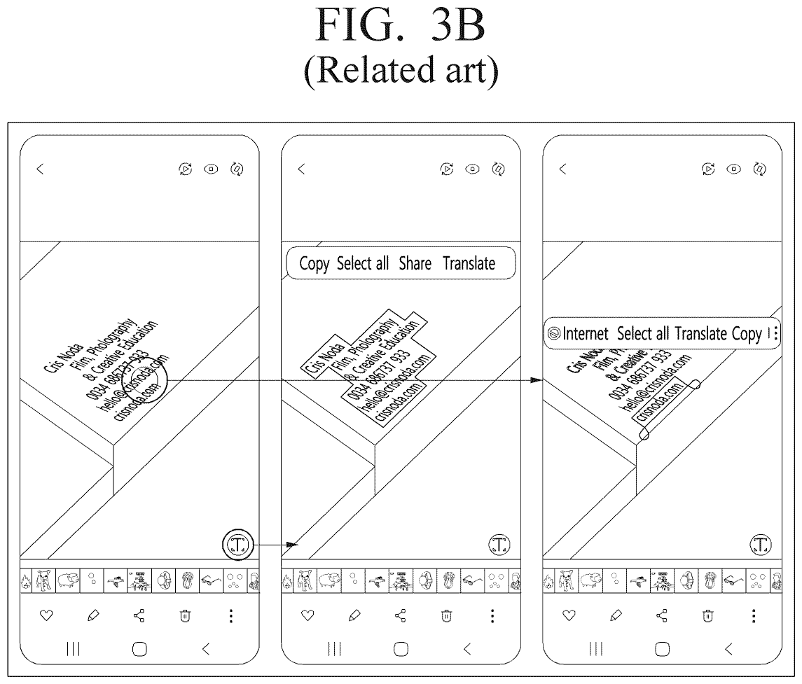

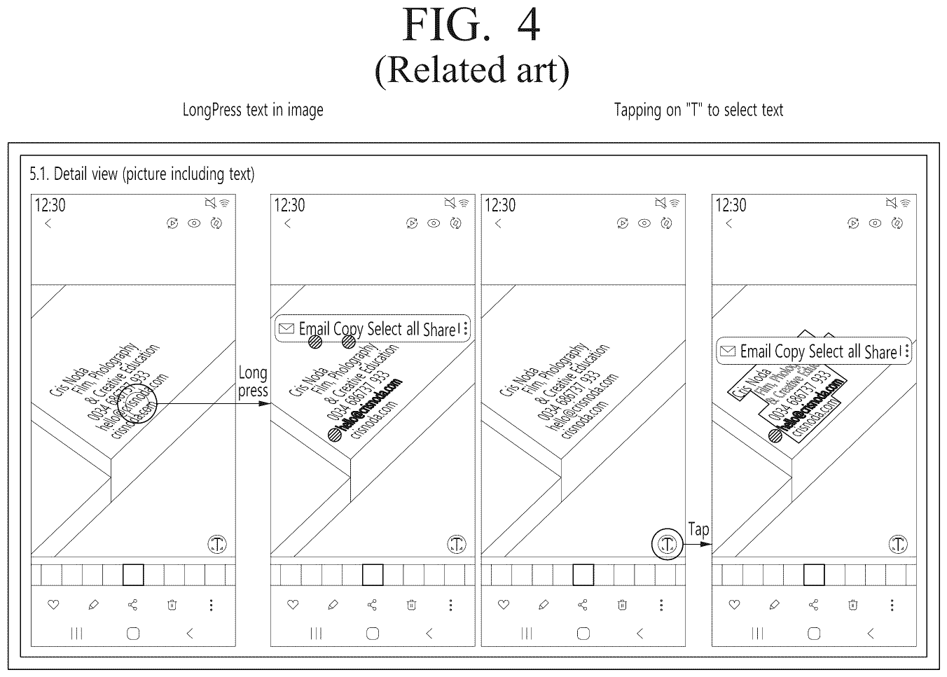

Throughout the drawings, it should be noted that like reference numbers are used to depict the same or similar elements, features, and structures.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

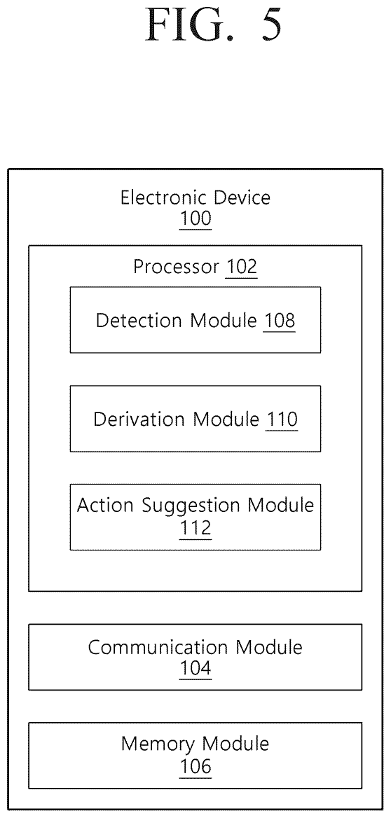

The embodiments herein achieve a device and methods for suggesting at least one action in an electronic device using different modalities. The modalities are selected from a media frame from a display of an electronic device. Referring now to the drawings, and more particularly to FIGS. 5 through 13, 14A, 14B, 15A, 15B, 16A, 16B, 17A, and 17B, where similar reference characters denote corresponding features consistently throughout the figures, there are shown embodiments.

FIG. 5 depicts the electronic device 100 for suggesting at least one action in the electronic device 100 using different modalities according to an embodiment of the disclosure.

The electronic device 100 comprises a processor 102, a communication module 104 and memory module 106. The electronic device 100 can be a real world device present in the real world environment of the user. Examples of the electronic device 100 can be, but not limited to, a desktop, a laptop, a smart phone, a personal digital assistant, a wearable device, a kitchen appliance, a smart appliance, a virtual reality device, and augmented reality device, or any other device which can capture media (such as, but not limited to, images, videos, animations, and so on). Although not shown in FIG. 5, the electronic device 100 may include a display and an input device. The display and the input device may be combined as, e.g., a touchscreen, or may be separate. The display may be physically coupled with, or physically separate from, the electronic device 100. The input device may recognize at least one of touches or gestures of a user as an input. The input may be a user selection. The input may correspond to content displayed on the display. The input device may be physically coupled with, or physically separate from, the electronic device 100.

In the embodiment shown herein, the processor 102 can be configured to detect the user selection of a first modality in the display of the electronic device 100 and at least one second modality present in the vicinity of the first modality. The first modality and at least one second modality are detected using a machine learning (ML) technique. The first modality can be the textual elements and the second modality can include at least one of the non-textual elements, but not limited to visual, video, audio, and stylus pen (spen).

In the embodiment shown herein, the processor 102 may comprise one or more of microprocessors, circuits, and other hardware configured for processing. The processor 102 can be configured to execute instructions stored in the memory module 106.

The processor 102 can be at least one of a single processer, a plurality of processors, multiple homogeneous or heterogeneous cores, multiple CPUs of different kinds, microcontrollers, special media, and other accelerators. The processor 102 may be an AP, a graphics-only processing unit such as a GPU, a visual processing unit (VPU), and/or an AI-dedicated processor such as a neural processing unit (NPU).

In the embodiment shown herein, the communication module 104 is configured to enable communication between the electronic device 100 and at least one external entity (such as, but not limited to, a server) through a network or cloud. The server may be configured or programmed to execute instructions of the electronic device 100. The communication module 104 through which the electronic device 100 and the server communicate may be in the form of either a wired network, a wireless network, or a combination thereof. The wired and wireless communication networks may comprise but not limited to, Global Positioning System (GPS), Global System for Mobile Communications (GSM), Local area network (LAN), Wireless Fidelity (Wi-Fi) compatibility, Bluetooth low energy (BLE), Near-field communication (NFC), and so on. The wireless communication may further comprise one or more of Bluetooth (registered trademark), Zonal Intercommunication Global-standard (ZigBee) (registered trademark), a short-range wireless communication such as Ultra-wideband (UWB), a medium-range wireless communication such as Wi-Fi (registered trademark) or a long-range wireless communication such as Third Generation (3G)/Fourth generation (4G) or Worldwide Interoperability for Microwave Access (WiMAX) (registered trademark), according to the usage environment.

In the embodiment shown herein, the memory module 106 may comprise one or more volatile and non-volatile memory components which are capable of storing data and instructions to be executed. Examples of the memory module 106 can be, but not limited to, NAND, embedded Multi Media Card (eMMC), Secure Digital (SD) cards, Universal Serial Bus (USB), Serial Advanced Technology Attachment (SATA), solid-state drive (SSD), and so on. The memory module 106 may also include one or more computer-readable storage media. Examples of non-volatile storage elements may include magnetic hard discs, optical discs, floppy discs, flash memories, or forms of electrically programmable memories (EPROM) or electrically erasable and programmable (EEPROM) memories. In addition, the memory module 106 may, in some examples, be considered a non-transitory storage medium. The term “non-transitory” may indicate that the storage medium is not embodied in a carrier wave or a propagated signal. However, the term “non-transitory” should not be interpreted to mean that the memory module 106 is non-movable. In certain examples, a non-transitory storage medium may store data that can, over time, change (e.g., in Random Access Memory (RAM) or cache).

The processor 102 can derive at least one pair of the first modality and the at least one second modality by correlating the first modality and the second modality and provide a suggestion(s) using a user-operable interface based on the derived pair. A user operation on the suggestion initiates at least one action by the user (such as, but not limited to, execution of at least one action on the first modality via the application, dismissing the suggestion, ignoring the suggestion, and so on). The processor 102 further comprises a detection module 108, a derivation module 110, and an action suggestion module 112.

In an embodiment shown herein, the detection module 108 can detect a user selection of a first modality in the display of the electronic device 100. Further, the detection module 108 can detect at least one second modality present in the vicinity of the first modality. The derivation module 110 can extract one or more textual elements and one or more non-textual elements from the first modality and at least one second modality. Further, the derivation module 110 can extract a positional embedding for each of the first modality and at least one second modality. Further, the derivation module 110 can combine the extracted one or more textual elements, one or more non-textual elements, and the positional embeddings of the first modality with at least one second modality. Further, the derivation module 110 can divide the received media frame into a plurality of patches. Further, the derivation module 110 can extract a patch embedding and the positional embedding from the plurality of patches. Further, the derivation module 110 can combine the extracted patch embedding and the positional embedding of the plurality of patches. Further, the derivation module 110 can combine the combined result of one or more textual elements, one or more non-textual elements, the positional embeddings of the first modality and at least one second modality, and the combined result of the patch embedding and the positional embedding of the plurality of patches. Further, the derivation module 110 can derive at least one pair of the first modality and at least one second modality by encoding and decoding the combined result. The action suggestion module 112 can provide the suggestion(s) using a user-operable interface based on the derived at least one pair of the first modality and at least one second modality via the application. The user operation on the suggestion initiates the execution of at least one action on the first modality via the application.

FIG. 5 shows example modules of the electronic device 100, but it is to be understood that other embodiments are not limited thereon. In other embodiments, the electronic device 100 may include less or more number of modules. Further, the labels or names of the modules are used only for illustrative purpose and does not limit the scope of the disclosure. One or more modules can be combined together to perform same or substantially similar function in the electronic device 100.

Although the FIG. 5 shows various hardware components of the electronic device 100, but it is to be understood that other embodiments are not limited thereon. In other embodiments, the electronic device 100 may include less or more number of components. Further, the labels or names of the components are used only for illustrative purpose and does not limit the scope of the disclosure. One or more components can be combined together to perform same or substantially similar function in the electronic device 100.

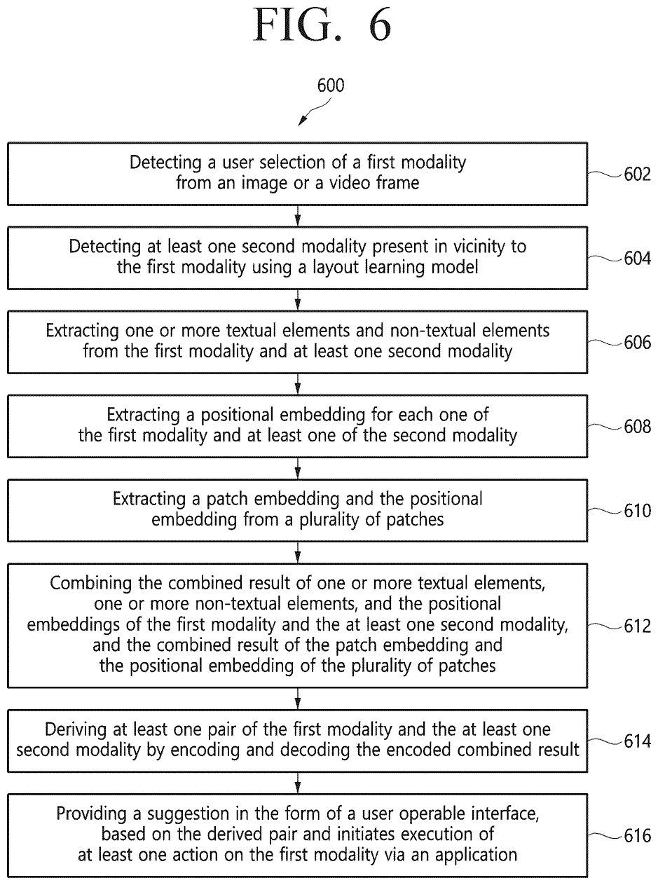

FIG. 6 is a flowchart illustrating a method 600 for suggesting at least one action in the electronic device 100 according to an embodiment of the disclosure.

The operations (602-616) are handled by the processor 102. At operation 602, the method may include detecting, by the electronic device 100, a user selection of a first modality in a display of the electronic device 100. The first modality is selected from the media frame from the display of the electronic device 100.

At operation 604, the method may include detecting, by the electronic device 100, at least one second modality present in the vicinity of the first modality. The first modality and at least one second modality can be detected using the ML technique. The first modality and at least one second modality comprise a pair of one or more textual elements and one or more non-textual elements. The second modality is detected in the vicinity of the first modality using a layout learning model.

At operation 606, the method may include extracting, by the electronic device 100, one or more textual elements and one or more non-textual elements from the first modality and at least one second modality.

At operation 608, the method may include extracting, by the electronic device 100, the positional embedding for each of the first modality and at least one second modality. Further, the method may include combining, by the electronic device 100, the extracted one or more textual elements, one or more non-textual elements, and the positional embeddings of the first modality and at least one second modality.

At operation 610, the method may include receiving, by the electronic device 100, the media frame from the display of the electronic device 100. Further, the method may include dividing, by the electronic device 100, the received media frame into a plurality of patches. Further, the method may include extracting, by the electronic device 100, the patch embedding and the positional embedding from the plurality of patches. Further, the method may include combining, by the electronic device 100, the extracted patch embedding and the positional embedding of the plurality of patches.

At operation 612, the method may include combining, by the electronic device 100, the combined result of the one or more textual elements, the one or more non-textual elements, the positional embeddings of the first modality and the at least one second modality, and the combined result of the patch embedding and the positional embedding of the plurality of patches.

At operation 614, the method may include encoding, by the electronic device 100, the combined result. The method may include deriving, by the electronic device 100, at least one pair of the first modality and the at least one second modality by encoding and decoding the combined result.

At operation 616, the method may include providing, by the electronic device 100, the suggestion using the user-operable interface, based on the derived pair. The user operation on the suggestion initiates the execution of at least one action on the first modality via the application.

The one or a plurality of processors control the processing of the input data in accordance with a predefined operating rule or AI model stored in the non-volatile memory and the volatile memory. The predefined operating rule or artificial intelligence model is provided through training or learning.

Here, being provided through learning means that a predefined operating rule or AI model of a desired characteristic is made by applying a learning algorithm to a plurality of learning data. The learning may be performed in a device itself in which AI according to an embodiment is performed, and/or may be implemented through a separate server/system. Examples of learning algorithms include, but are not limited to, supervised learning, unsupervised learning, semi-supervised learning, or reinforcement learning.

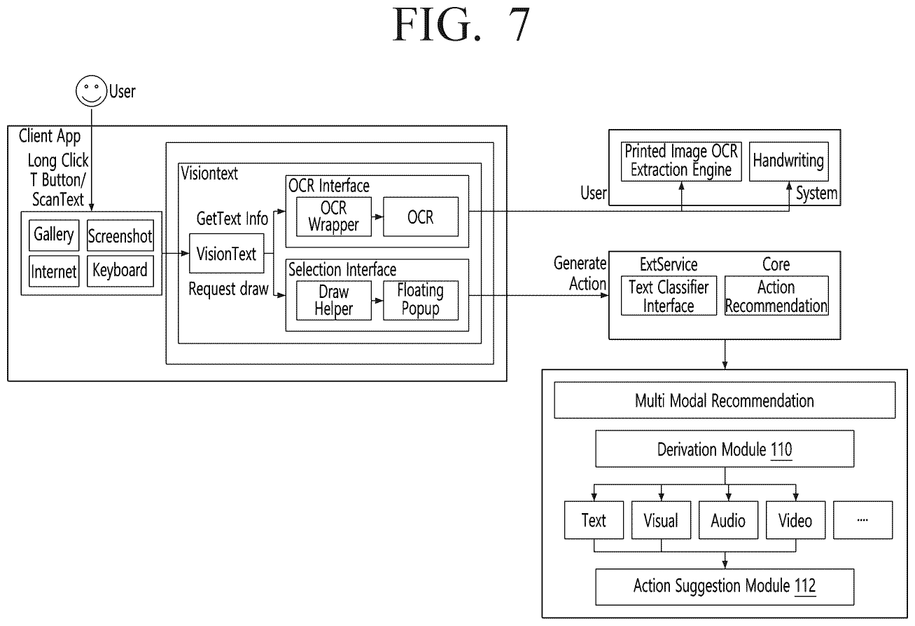

FIG. 7 depicts an overall architecture of a multi modal recommendation according to an embodiment of the disclosure.

The architecture depicts the device integration or interconnection of all the device's components with the device features based on the different modalities, provides actionable suggestion(s) using the user-operable interface, and initiates at least one action by the user (such as, but not limited to, execution of at least one action on the first modality via the application, dismissing the suggestion, ignoring the suggestion, and so on). The modalities are selected from a media frame from the display of the electronic device 100. The modalities comprise at least one of one or more textual elements and one or more non-textual elements.

The user selects at least one portion of the media from the electronic device 100 and selects an option using a pre-defined gesture (such as, but not limited to, a long press, a T button, and selecting a ‘Scan Text’ option, drawing a box around the text), on text present in a display of an electronic device 100. The media can include at least one of, but not limited to, one camera-captured media, one screenshot, one computer-generated media, and one media shared across social networking sites.

The electronic device 100 performs an optical character recognition (OCR) on one or more blocks of the media to recognize the text using visiontext, which includes a selection interface and an OCR interface. The electronic device 100 gets text information through the OCR interface using an OCR wrapper. In an embodiment shown herein, the OCR uses scene text recognition using a printed image OCR extraction engine and handwriting. The electronic device 100 requests drawing action popup through the selection interface using a draw helper and floating popup and generates the actions based on an action recommendation. In an embodiment shown herein, a text classifier interface mechanism can be used to extract the entity from the media.

The detection module 108 detects a user selection of a first modality on a display of the electronic device 100. The first modality can be the textual elements. The detection module 108 detects at least one second modality present in the vicinity of the first modality. The second modality can include at least one of the non-textual elements, but not limited to visual, video, audio, and spen. In an embodiment herein, the first modality and the at least one second modality can be detected using the ML technique. Further, the derivation module 110 can derive at least one pair of the first modality and the at least one second modality by correlating the first modality and the at least one second modality. Further, the action suggestion module 112 provides suggestion(s) using the user-operable interface, based on the derived pair, and initiates at least one action by the user (such as, but not limited to, execution of at least one action on the first modality via the application, dismissing the suggestion, ignoring the suggestion, and so on).

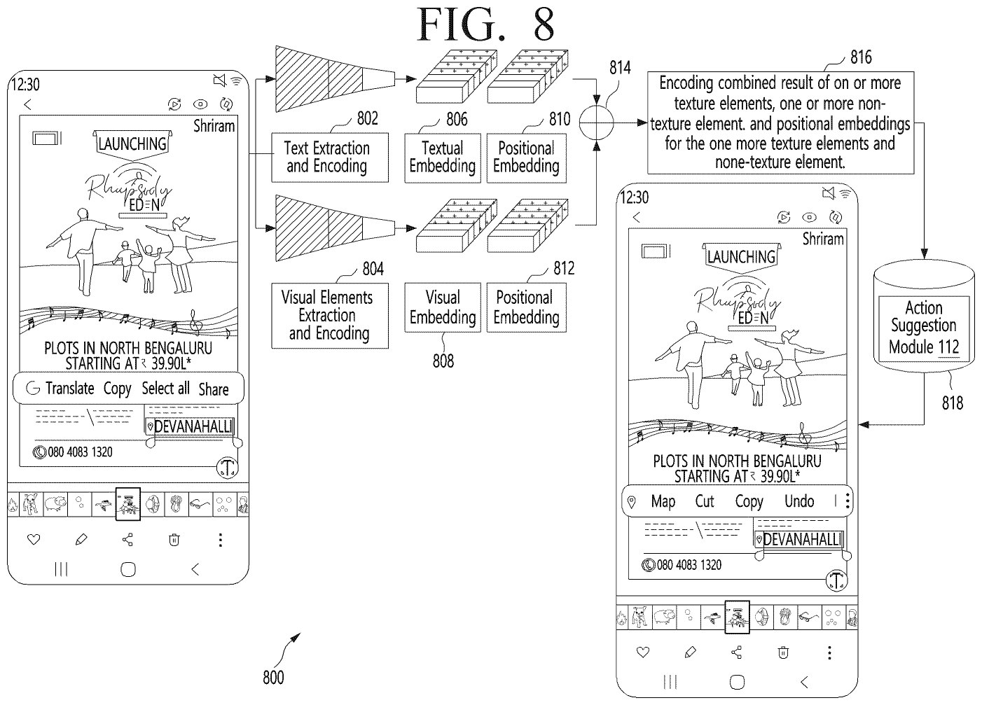

FIG. 8 is a flow diagram 800 depicting an overall pipeline of the multi modal recommendation according to an embodiment of the disclosure.

At operation 802, the one or more textual elements (first modality) from the media in the electronic device 100 are extracted. At operation 804, the one or more non-textual (visual) elements (second modality) are extracted from the media in an electronic device 100, which is present in the vicinity of the first modality in the media. Further, at operation 806, the textual embeddings are created for the one or more textual elements. At operation 808, the non-textual (visual) embeddings are created for the one or more non-textual elements (visual elements). Further, at operation 810, the positional embedding is created for the one or more textual elements. At operation 812, the positional embedding is created for the one or more non-textual elements (visual elements). Further, at operation 814, the extracted one or more textual elements (textual embeddings), the one or more non-textual elements (visual embeddings), and the positional embeddings of the one or more textual elements and non-textual elements (visual elements) are combined. Further, at operation 816, the combined result of one or more textual elements, the one or more non-textual elements, and positional embeddings for the one or more textual elements and non-textual elements (visual elements) are encoded. Further, at least one pair of the first modality and at least one second modality is derived by encoding and decoding the encoded combined result. At operation 818, the actionable suggestion is provided by the action suggestion module 112 based on the derived pair on the first modality via the application.

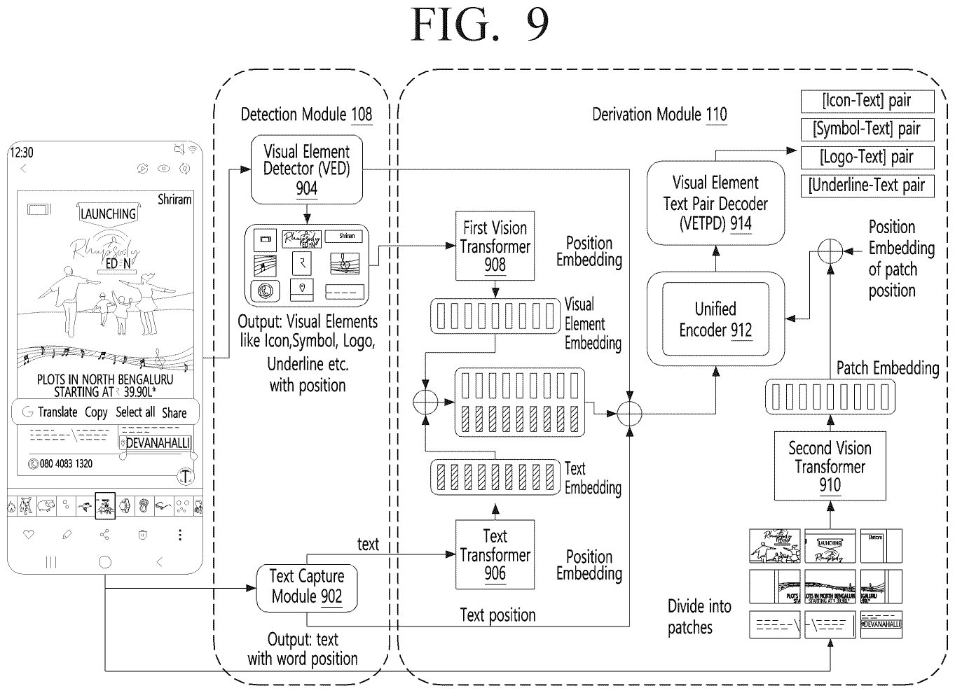

FIG. 9 depicts a block representation for selecting the different modalities from the media according to an embodiment of the disclosure.

The detection module 108 can detect the first modality and second modality from the input media in the electronic device 100. The detection module 108 comprises a text capture module 902 and a Visual Element Detector (VED) 904. The text capture module 902 performs an OCR on the input media to extract the text information (block, line, word rectangle, and so on) and includes the information of the location of the text information on the image along with the text (text with word position). The VED 904 can detect and extract all the non-textual (visual) elements with their respective positions from the given input media, including but not limited to icons, symbols, logos, underlines, and so on, excluding the textual elements present in it.

The derivation module 110 derives at least one pair of the first modality and the at least one second modality by correlating the first modality and the at least one second modality. The pair of the first modality and at least one second modality comprises at least one pair of one or more textual elements and one or more non-textual (visual) elements. The derivation module 110 comprises a text transformer 906, a first vision transformer 908, a second vision transformer 910, a unified encoder 912, and a Visual Element Text Pair Decoder (VETPD) 914. The text transformer 906 can learn context and meaning by understanding the relationships in sequential data, like words extracted from the text capture module 902, where the user has selected using the gesture. The text transformer 906 can determine the kind of text, whether it is alphabets or numerals. The text capture module 902 can extract one or more textual elements and provide the extracted text to the text transformer 906 for generating the textual embeddings. The textual embedding comprises the representation of texts. The VED 904 can extract the visual elements from the media and provide the extracted visual elements to the first vision transformer 908 for generating the visual element embeddings. The first vision transformer 908 can represent the extracted visual elements given by the VED 904 into sequence, class, and labels, which allows the first vision transformer 908 to learn image structures independently. The electronic device 100 can divide the received input media into a plurality of patches and flatten and reshape the plurality of patches in 1D sequence, which passes through the patch and positional embedding layers. The second vision transformer 910 can extract a patch embedding and the positional embedding from the plurality of patches. The positional embedding encodes the positional information and describes the location or position of an entity in transformer architecture.

The electronic device 100 can extract information of the positional embedding of textual and non-textual (visual) elements from the given input media. The electronic device 100 can combine the extracted one or more textual elements, the one or more non-textual elements, and positional embeddings of the first modality with at least one second modality. Further, the electronic device 100 can combine the extracted patch embedding and the positional embedding of the plurality of patches. Further, the electronic device 100 can combine the combined result of the one or more textual elements, the one or more non-textual elements, the positional embeddings of the first modality and the at least one second modality, and the combined result of the patch embedding and the positional embedding of the plurality of patches and feed them to the unified encoder 912.

Using the textual elements (word features and word embeddings) and non-textual elements (visual element features), the unified encoder 912 can patch details of the media frame and make all of those into encoded features. The unified encoder 912 can determine the association between the outputs of textual element embedding and non-textual (visual) element embedding with positional embedding.

The VETPD 914 can determine the pairing between the textual element embeddings and the non-textual (visual) elements. The VETPD 914 can determine the relationship between a key and a value. The key refers to the non-textual (visual) elements, which can include but not limited to icon, logo, symbol, and underline, and the value refers to the textual elements available in the user-selected portion. Based on the determined relation between the key and the value, the VETPD 914 can provide a pair-based analysis of the key-value ground truth provided during the model training. For example, key (here it is a symbol) & value (text like Devanahalli, 08040831320, etc.). The VETPD 914 module can determine the kind of pair based on the pair identification and classification trained model, such as, but not limited to, the logo-text pair, symbol-text pair, icon-text pair, and underline-text pair.

The action suggestion module 112 can provide the suggestion(s) using the user-operable interface based on the derived pair. The user operation on the suggestion initiates at least one action by the user (such as, but not limited to, execution of at least one action on the first modality via the application, dismissing the suggestion, ignoring the suggestion, and so on).

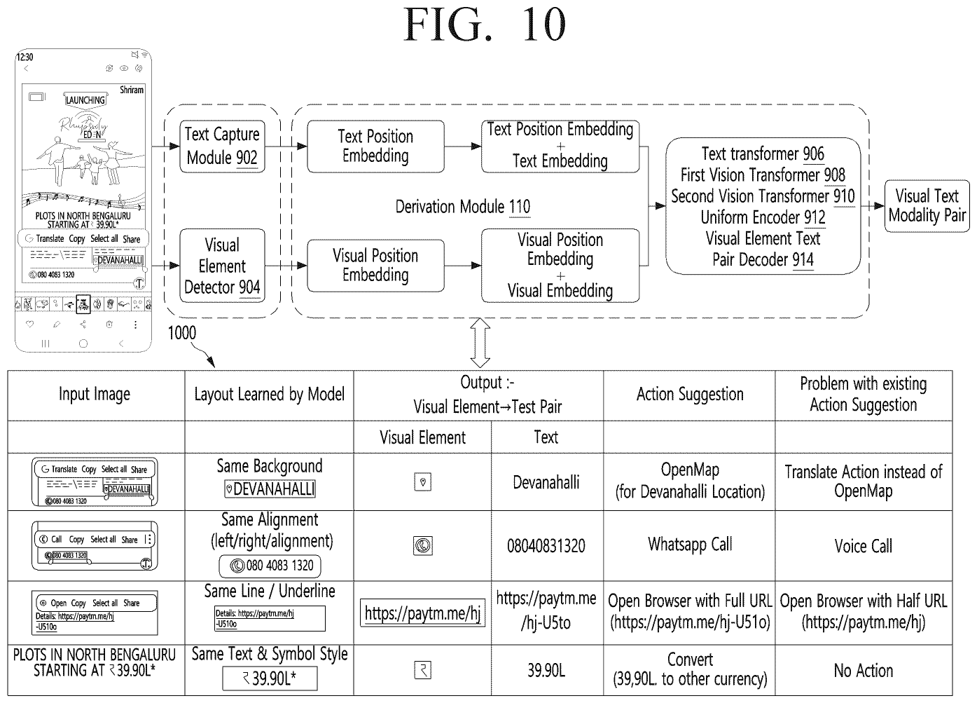

FIG. 10 is an example diagram depicting the selection of the visual modality from the entire media frame in connection with Table 1000, as shown in FIG. 10, according to an embodiment of the disclosure.

The detection module 108 comprises the text capture module 902 and the visual element detector 904. The text capture module 902 can perform an OCR on the input media frame to extract one or more textual elements (first modality) from the media in the electronic device 100. The VED 904 can detect and extract one or more non-textual (visual) elements (second modality) from the given input media. Further, the derivation module 110 extracts a positional embedding for one or more textual elements and non-textual elements (visual elements). Further, the derivation module 110 combines the extracted textual embedding, the non-textual embedding (visual elements), and the positional embeddings of the one or more textual elements and non-textual elements (visual elements). Further, the derivation module 110 (text transformer 906, the first vision transformer 908, the second vision transformer 910, the unified encoder 912, the VETPD 914) encodes the combined result of the extracted textual embedding, the non-textual embedding (visual elements), and the positional embeddings of the one or more textual elements and non-textual elements (visual elements). Further, the derivation module 110 derives at least one pair (visual text modality pair) of the first modality and at least one second modality by decoding the encoded combined result.

The VED 904 module can detect and extract one or more non-textual (visual) elements (second modality) from the given input media in the vicinity of the first modality using a layout learning model based on at least one of, but not limited to, the same background, alignment, line, underline, font, symbol, and style.

The examples shown in Table 1000 as shown in FIG. 10, the detection module 108 detects a user selection of one or more textual elements (first modality) as “Devanahalli” and one or more non-textual elements (second modality) as the “map” icon present beside the textual information based on the same background in a display of the electronic device 100 using the learning layout model, which indicates Devanahalli as a location. The derivation module 110 derives the [Icon-Text] pair of the first modality and second modality. The action suggestion module 112 provides the suggestion for at least one action, “OpenMap” for the Devanahalli location instead of the “Translate” action, along with the Cut, Copy, and Select All options.

Similarly, the detection module 108 detects a user selection of one or more textual elements (first modality) as “08040831320” and one or more non-textual elements (second modality) as the “WhatsApp” icon present beside the textual information based on the same alignment (left/right/alignment) in a display of the electronic device 100 using the learning layout model. The derivation module 110 derives the [Logo-Text] pair. The action suggestion module 112 provides the suggestion for at least one action, “WhatsApp call,” for the 08040831320 number instead of the “voice call” action, along with Cut, Copy, and Select All options.

Similarly, the detection module 108 detects a user selection of one or more textual elements (first modality) as “https://paytm.me/hj-u510” and one or more non-textual elements (second modality) as “underline” present in the vicinity to the textual information based on the same line or underline in a display of the electronic device 100 using the learning layout model. The derivation module 110 derives the [Underline-Text] pair. The action suggestion module 112 provides the suggestion for at least one action, “Open Browser” with a full URL (https://paytm.me/hj-u510), instead of “Open Browser” with a half URL (https://paytm.me/hj), along with the Cut, Copy, and Select All options.

Similarly, the detection module 108 detects a user selection of one or more textual elements (first modality) as “39.90L” and one or more non-textual elements (second modality) as “ [symbol] ” present in the vicinity of the textual information in a display of the electronic device 100 using a learning layout model based on the same text and symbol style. The derivation module 110 derives the [Symbol-Text] pair. The action suggestion module 112 provides the suggestion for at least one action, “convert (39.90 1 to another currency)” instead of “No Action,” along with Cut, Copy, and Select All options.

Table 2 and Table 3 show positional embedding calculations for text modality. This table shows the positional encoding matrix for the sequence “with Threshold Acres Devanahalli”. k represents an index of tokens with values from 0 to 4. The value of k of the input sequence as with=0, Threshold=1, Acres=2, and Devanahalli=3. The positional encoding matrix is defined with d=4 and n=100.

TABLE 2

| | Index | | | | |
|---|---|---|---|---|---|
| | of | Positional Encoding matrix with | | | |
| | Tokens | d = 4, n = 100 | | | |
| Sequence | k | i = 0 | i = 1 | i = 2 | i = 3 |
| with | 0 | P00 | P01 = | P02 | P03 |
| | | = sin(0) | cos(0) = | = sin(0) | = cos(0) |
| | | = 0 | 1 | = 0 | = 1 |
| Threshold | 1 | P10 | P11 | P12 | P13 |
| | | = sin(1/1) | = cos(1/1) | = sin(1/10) | = cos(1/10) |
| | | = 0.84 | = 0.54 | = 0.10 | = 1.0 |
| Acres | 2 | P20 | P21 | P22 | P23 |
| | | = sin(2/1) | = cos(2/1) | = sin(2/10) | = cos(2/10) |
| | | = 0.91 | = −0.42 | = 0.20 | = 0.98 |
| Devanahalli | 3 | P30 | P31 | P32 | P33 |
| | | = sin(3/1) | = cos(3/1) | = sin(3/10) | = cos(3/10) |
| | | = 0.14 | = −0.99 | = 0.30 | = 0.96 |

TABLE 3

| Input | | | | |
|---|---|---|---|---|
| Sequence | with | Threshold | Acres | Devanahalli |
| word | vo | v1 | v2 | v3 |
| embedding | = Embedding | = Embedding | Embedding | = Embedding |
| | Vector(with) | Vector | Vector | Vector |
| | | (Threshold) | (Acres) | (Devanahalli) |
| Positional | po | p1 | p2 | p3 |
| Embedding | = Positional | = Positional | = Positional | = Positional |
| matrix | Vector(with) | Vector | Vector | Vector |
| | | (Threshold) | (Acres) | (Devanahalli) |
| Output of | y0 | y1 | p2 | p3 |
| Positional | = Positional | = Positional | = Positional | = Positional |
| Encoding | Encoding | Encoding | Encoding | encoding |
| layer | (with) | (Threshold) | (Acres) | (Devanahalli) |

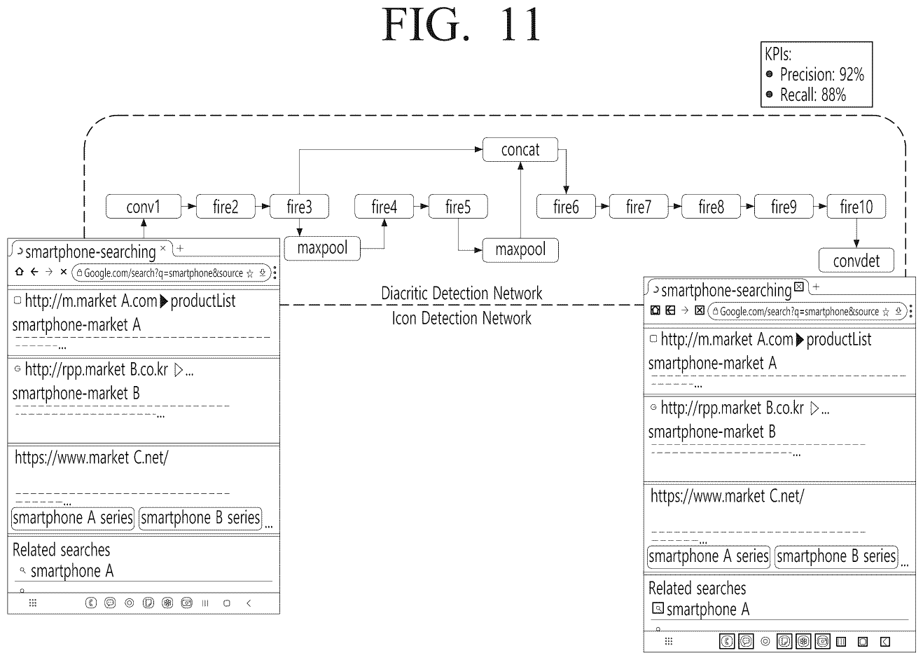

FIG. 11 depicts an icon detection machine learning model to detect the visual modality (icon) for the given input image according to an embodiment of the disclosure.

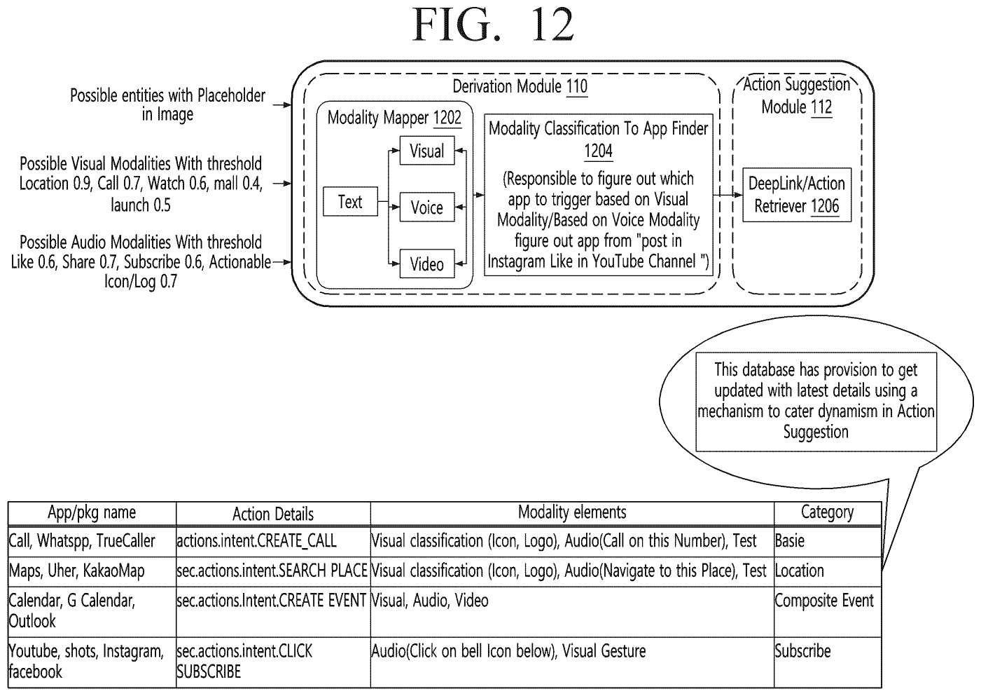

FIG. 12 depicts a system flow representation for suggesting at least one action in an electronic device 100 according to an embodiment of the disclosure.

The detection module 108 can detect the user selection of the first modality and at least one second modality present in the vicinity of the first modality. The derivation module 110 can derive at least one pair of the first modality and at least one second modality by correlating the first modality and at least one second modality. The derivation module 110 comprises a modality mapper 1202 and a modality classification to app finder 1204. The modality mapper 1202 can determine the association between the first modality and the second modality. The modality classification to app finder 1204 can determine the connection of the second modality with the application by classifying the second modality into a predefined category. The modality classification to app finder 1204 can figure out which app to trigger based on different modalities, such as, but not limited to, a visual modality, a voice modality, and a video modality. For example, based on the different modalities, the modality classification to app finder 1204 can figure out the app from a post on Instagram or a Youtube channel. The modality classification to app finder 1204 can map the classified second modality to the application. The action suggestion module 112 comprises an action retriever 1206. The action retriever 1206 can retrieve at least one actionable suggestion(s) using the user-operable interface. The user operation on the suggestion initiates execution of at least one action on the first modality (textual element) via the application.

In the example shown herein, the action retriever 1206 provides the action details (actions.intent.CREATE_CALL) based on the determined application (a dialer application, WhatsApp, Truecaller). The modality elements identified as visual classification (icon, logo), audio (call on this number), and text in a basic category from a database (not shown). If the determined application is a WhatsApp logo, then the action suggestion module 112 provides the actionable suggestion for the WhatsApp call instead of the normal voice call.

The action retriever 1206 provides the action details (sec.actions.intent.SEARCH_PLACE) based on the determined application (Maps, Uber, KakaoMap). The modality elements identified as visual classification (icon, logo), audio (navigate to this place), and text in a location category from the database (not shown) for searching a place in the map.

The action retriever 1206 provides the action details (sec.actions.intent.CREATE_EVENT) based on the determined application (Calendar, G Calendar, Outlook). The modality elements identified as visual, audio, and video in a composite event category from the database (not shown) for creating the event.

The action retriever 1206 provides the action details (sec.actions.intent.CLICK_SUBSCRIBE) based on the determined application (Youtube, Shots, Instagram, and Facebook). The modality elements can be audio (click on the bell icon below) or visual gestures in a subscribe category from the database (not shown) for subscribing to the application.

The database (not shown) can be updated with the latest details using a configuration policy mechanism to cater to dynamism in action suggestions. The configuration policy mechanism is used to update the configuration runtime without the need for updating entire mobile device software or application software

The database (not shown) may comprise one or more volatile and non-volatile memory components that are capable of storing data and instructions to be executed. Examples of the database (not shown) can be, but not limited to, NAND, embedded Multimedia Card (eMMC), Secure Digital (SD) cards, Universal Serial Bus (USB), Serial Advanced Technology Attachment (SATA), solid-state drive (SSD), and so on. The database (not shown) may also include one or more computer-readable storage media. Examples of non-volatile storage elements may include magnetic hard discs, optical discs, floppy discs, flash memories, or forms of electrically programmable memories (EPROM) or electrically erasable and programmable (EEPROM) memories. In addition, the database (not shown) may, in some examples, be considered a non-transitory storage medium. The term “non-transitory” may indicate that the storage medium is not embodied in a carrier wave or a propagated signal. However, the term “non-transitory” should not be interpreted to mean that the database (not shown) is non-movable. In certain examples, a non-transitory storage medium may store data that can, over time, change (e.g., in Random Access Memory (RAM) or cache).

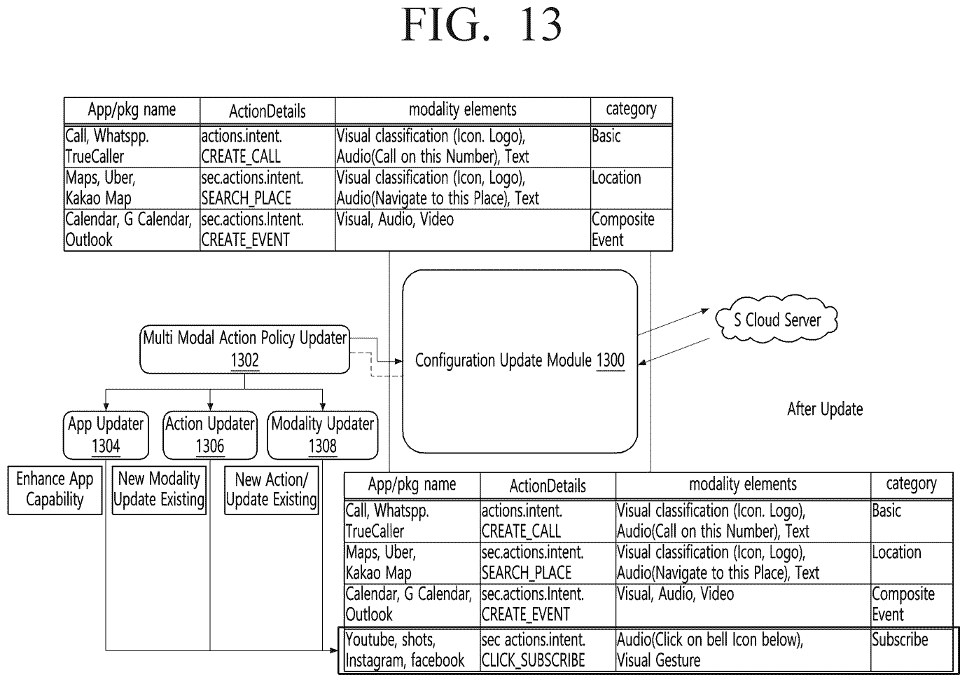

FIG. 13 depicts a method for performing dynamic updation according to an embodiment of the disclosure.

In an embodiment shown herein, if any change occurs in the existing configuration, the changes made in the configuration are updated automatically by the server using a configuration update module 1300 instead of getting updates from software.

In the embodiment shown herein, the electronics device 100 comprises a multi modal action policy updater module 1302 for updating the modality (ies), the action(s), and the app(s) dynamically. The multi modal action policy updater module 1302 comprises an app updater module 1304, an action updater module 1306, and a modality updater module 1308. The app updater module 1304 can enhance the app capability and update the application with the latest version. The action updater module 1306 can update the existing actions and include new actions accordingly. The modality updater module 1308 can update the existing modalities and include new modalities accordingly.

The multi modal action policy updater module 1302 can provide the action details after updating the application, action, and modalities as (sec.actions.intent.CLICK_SUBSCRIBE) based on the updated application (Youtube, Shots, Instagram, Facebook). The modality elements can be Audio (Click on the bell Icon below), and visual gestures in a subscribe category from the database (not shown) for subscribing to the updated application.

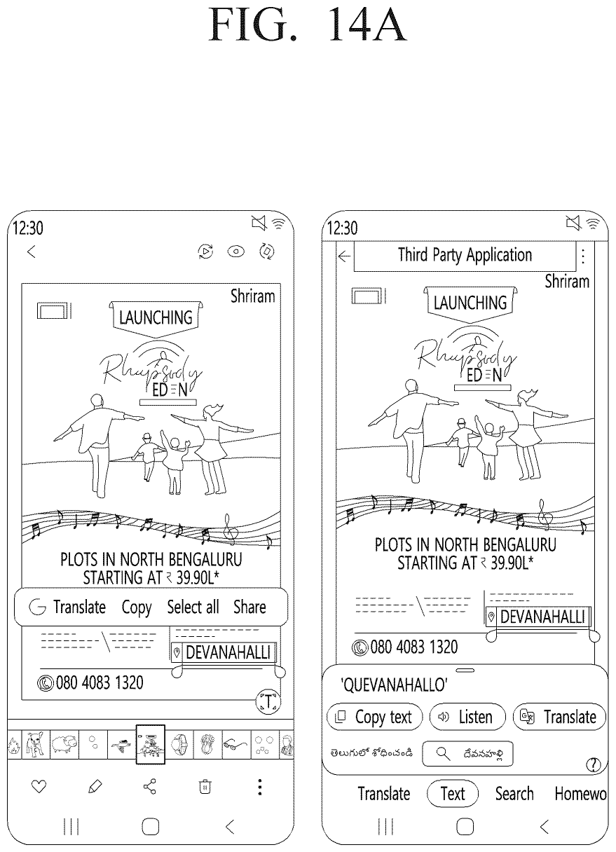

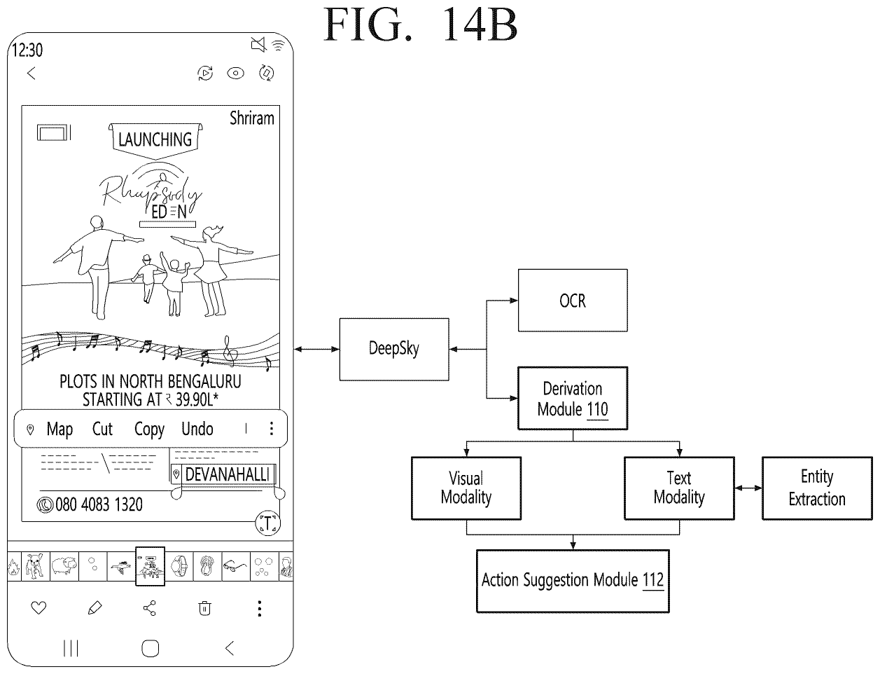

FIG. 14A depicts an example scenario, wherein Devanahalli cannot be identified as the place, person, or other entity, according to an embodiment of the disclosure.

FIG. 14B depicts an example scenario according to an embodiment of the disclosure.

In the example shown herein, “Devanahalli” is identified as the first modality, and the map icon is identified as the second modality. Based on the additional modality (icon) present near the textual elements, the multi modal ambiguity is resolved, and Devanahalli is mapped as a location entity. The detection module 108 performs the OCR on the input image and detects one or more textual elements (first modality) and at least one non-textual element (second modality) present near the textual element (first modality). The first modality and at least one second modality are detected using the ML technique. The derivation module 110 performs entity extraction and derives at least one pair of the first modality and at least one second modality. The action suggestion module 112 provides the suggestion(s) based on the derived pair of the first modality and at least one second modality via the application and initiates at least one action by the user (such as, but not limited to, execution of at least one action on the first modality via the application, dismissing the suggestion, ignoring the suggestion, and so on). The derivation module 110 derives the [Icon-Text] pair of the first modality and second modality. The action suggestion module 112 provides the suggestion for at least one action, “OpenMap” for Devanahalli Location instead of the “Translate” action, along with the (Cut, Copy, and Select All) option using long press and voice as a medium of interaction.

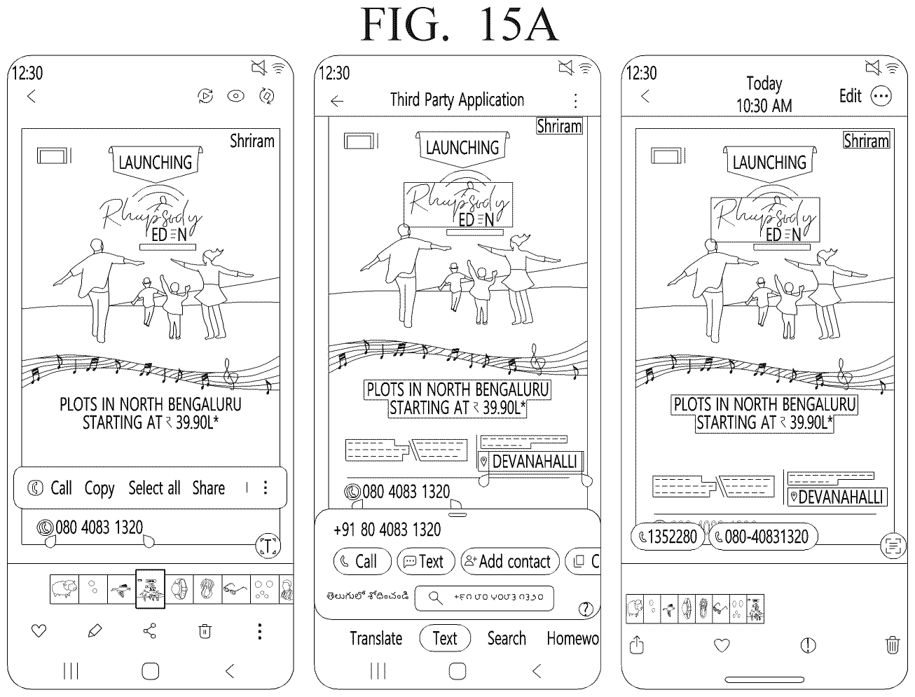

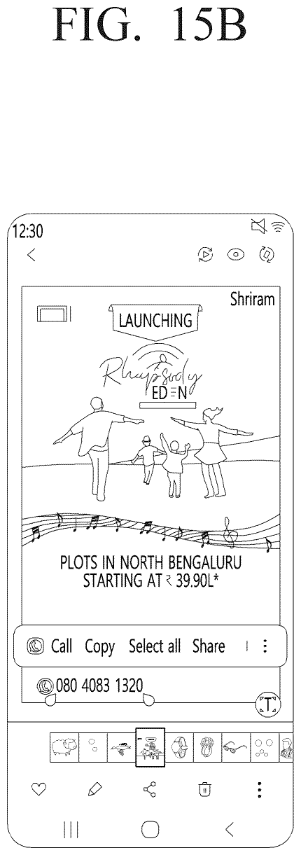

FIG. 15A depicts an example scenario, wherein the WhatsApp call is identified as the normal voice call and the call is initiated in the default voice call application, according to an embodiment of the disclosure.

FIG. 15B depicts an example scenario according to an embodiment of the disclosure. In this example shown herein, “08040831320” is identified as the first modality, and the WhatsApp logo is identified as the second modality. The caller application ambiguity is resolved. The derivation module 110 derives the [Logo-Text] pair of the first modality and second modality based on the additional visual modality (icon) extraction near the phone number and icon application classification mechanism. The action suggestion module 112 provides the suggestion for at least one action, “WhatsApp call” for “08040831320” (a mobile number), instead of the “voice call” action, along with the Cut, Copy, and Select All options.

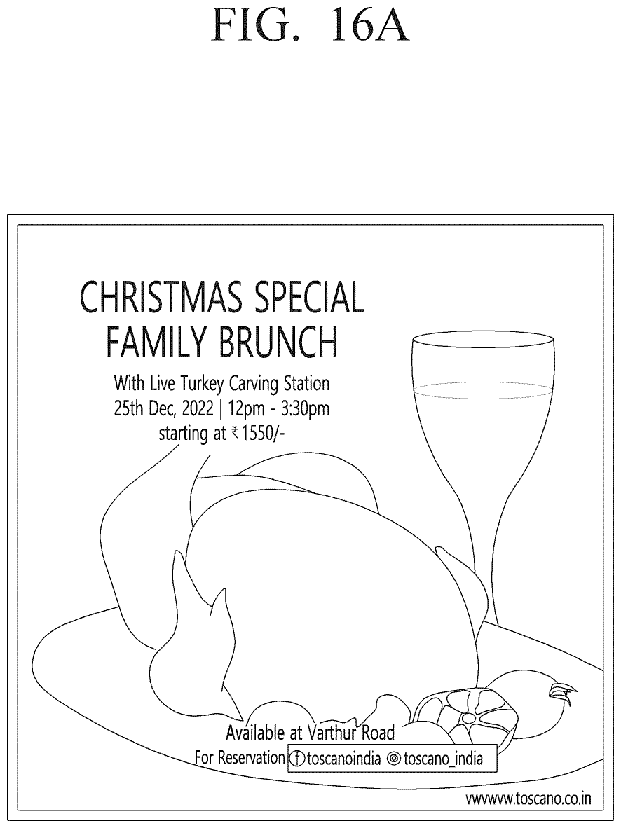

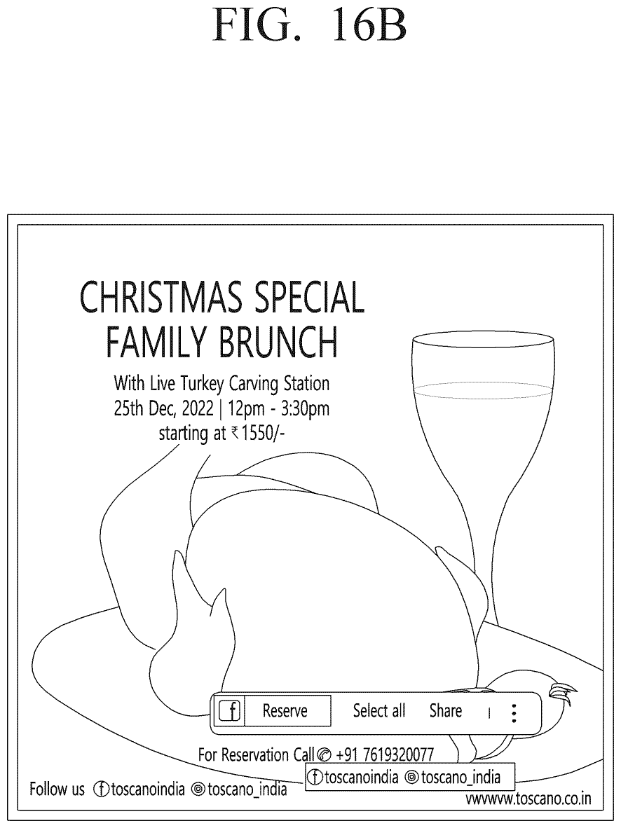

FIG. 16A depicts an example scenario, in which a reservation or booking cannot take place without a visual modality present near the textual elements because the text alone cannot be utilized for booking, according to an embodiment of the disclosure.

FIG. 16B depicts an example scenario according to an embodiment of the disclosure, wherein the reservation or booking is happening through a confirmation from social media applications, such as, but not limited to, Twitter, Facebook, and Instagram. In the example shown herein, the social media ID represents the visual modality (second modality). Based on the additional visual modality (icon) extraction with textual elements, the derivation module 110 extracts the entity and derives the pair of first modality (text) and second modality (visual modality (icon)). The action suggestion module 112 provides the suggestion for at least one action as “Reserve” for booking along with the Select All and Share options. Any person can reserve or confirm a booking only through a social media application ID, such as a Twitter ID, Facebook ID, or Instagram ID. The new entity recognition is resolved, and direct reservations can be made by replying with a Facebook ID or Instagram ID.

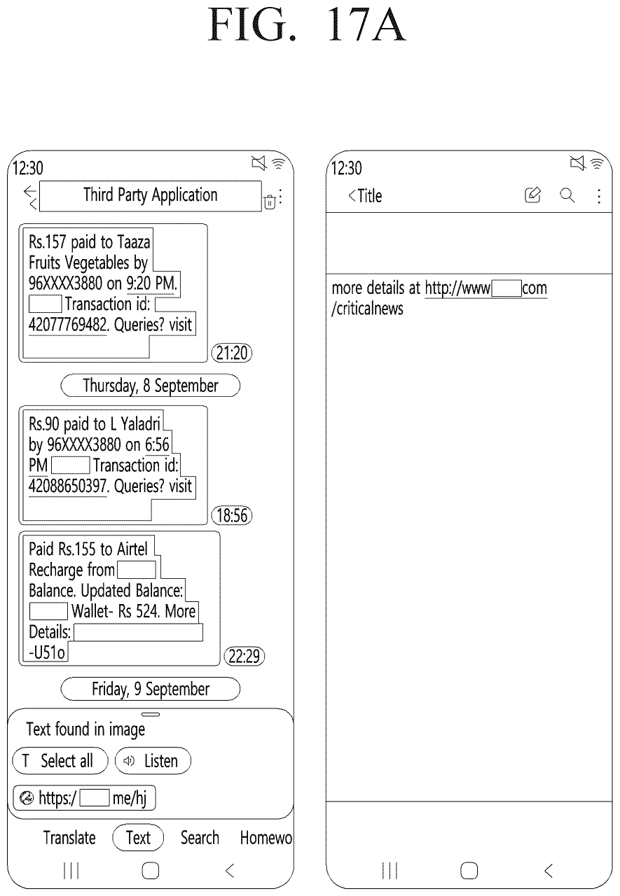

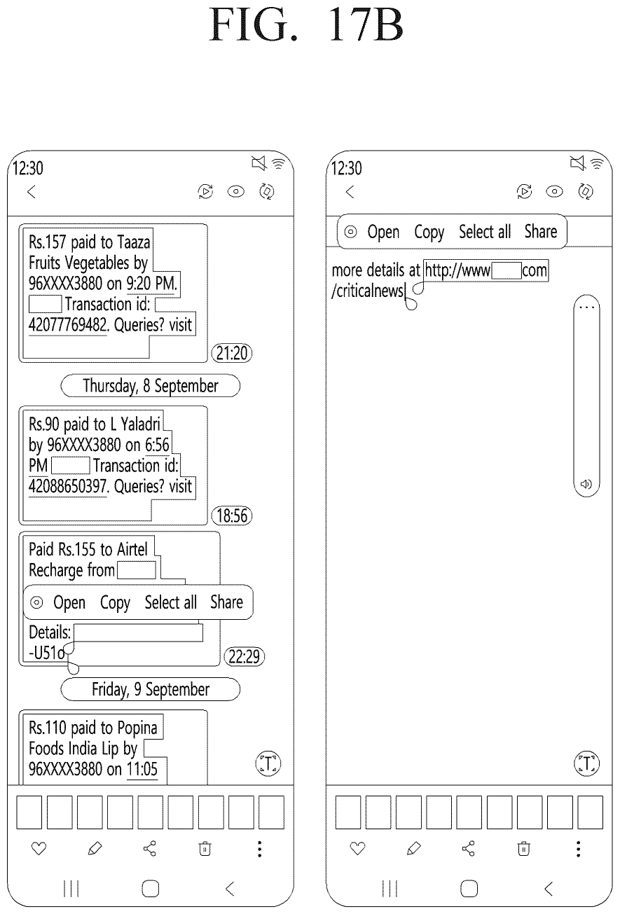

FIG. 17A depicts an example scenario, wherein the entire URL is not detected, even if it is continuous text and underlined in color clearly for the given input image or if it is present in a new line, according to an embodiment of the disclosure.

FIG. 17B depicts an example scenario according to an embodiment of the disclosure. In the example shown herein, the text “https://paytm.me/hj-U510” is identified as the first modality. The derivation module 110 performs entity extraction and derives the [Underline-Text] pair of the first modality and second modality based on the visual modality (boundary, color, underline) present in the input and considers it a single entity. The entity correctness issue is resolved. The action suggestion module 112 provides the suggestion for at least one action, “Open Browser” with full URL “https://paytm.me/hj-U510” instead of “Open Browser” with half URL “https://paytm.me/hj” action, along with Copy, Select All, and Share options.

In another example shown herein, the text “https:/www.ndtv.com/criticalnews” is identified as a first modality. The derivation module 110 performs entity extraction and derives the [Underline-Text] pair of the first modality and second modality based on the visual modality (boundary, color, underline) present in the image and considers it a single entity. The action suggestion module 112 provides the suggestion for at least one action, “Open Browser” with full URL “https:/www.ndtv.com/critical news” instead of “Open Browser” with half URL “https:/www.ndtv.com” action, along with Copy, Select All, and Share options.

The various actions, acts, blocks, steps, or the like in the method 600 and the flow diagram 800 may be performed in the order presented, in a different order or simultaneously. Further, in some embodiments, some of the actions, acts, blocks, steps, or the like may be omitted, added, modified, skipped, or the like without departing from the scope of the disclosure.

The embodiments disclosed herein can be implemented through at least one software program running on at least one hardware device. The modules shown in FIG. 5 include blocks which can be at least one of a hardware device, or a combination of hardware device and software module.

The embodiment disclosed herein describes a device and methods for suggesting at least one action in an electronic device 100 using different modalities. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g. hardware means like e.g. an ASIC, or a combination of hardware and software means, e.g. an ASIC and an FPGA, or at least one microprocessor and at least one memory with software modules located therein. The method embodiments described herein could be implemented partly in hardware and partly in software. Alternatively, the disclosure may be implemented on different hardware devices, e.g. using a plurality of CPUs.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by an electronic device for suggesting at least one action, the method comprising:
detecting, by the electronic device, a user selection of a first modality in a display of the electronic device;
detecting, by the electronic device, at least one second modality present in vicinity to the first modality;
deriving, by the electronic device, at least one pair of the first modality and the at least one second modality by correlating the first modality and the at least one second modality; and
providing, by the electronic device, a suggestion in a form of a user operable interface, based on the derived at least one pair,
wherein a user operation on the suggestion initiates execution of the at least one action on the first modality via an application.

2. The method as claimed in claim 1, wherein the first modality is selected from one of an image or a video frame from the display of the electronic device.

3. The method as claimed in claim 2, further comprising:
receiving, by the electronic device, one of the image or the video frame from the display of the electronic device;
dividing, by the electronic device, the received one of the image or the video frame into a plurality of patches;
extracting, by the electronic device, a patch embedding and a positional embedding from the plurality of patches; and
combining, by the electronic device, the extracted patch embedding and the positional embedding of the plurality of patches.

4. The method as claimed in claim 1, wherein the first modality and the at least one second modality are detected using a machine learning (ML) technique.

5. The method as claimed in claim 1, wherein the at least one second modality is detected in vicinity to the first modality using a layout learning model.

6. The method as claimed in claim 1, wherein the at least one pair of the first modality and the at least one second modality comprises:
a pair of one or more textual elements, and
one or more non-textual elements.

7. The method as claimed in claim 6, further comprising:
extracting, by the electronic device, the one or more textual elements and the one or more non-textual elements from the first modality and the at least one second modality;
extracting, by the electronic device, a positional embedding for each one of the first modality and the at least one second modality; and
combining, by the electronic device, the extracted one or more textual elements, the one or more non-textual elements, and positional embeddings of the first modality and the at least one second modality.

8. The method as claimed in claim 7, further comprising:
combining the combined result of the extracted one or more textual elements, the one or more non-textual elements, and the positional embeddings of the first modality and the at least one second modality, and a combined result of a patch embedding and a positional embedding of a plurality of patches;
encoding the combined result; and
deriving the at least one pair of the first modality and the at least one second modality by encoding and decoding the combined result.

9. The method as claimed in claim 1, wherein another user operation on the suggestion includes at least one of dismissing the suggestion or ignoring the suggestion.

10. An electronic device for suggesting at least one action, the electronic device comprises:
a display;
memory storing one or more computer programs; and
one or more processors communicatively coupled to the display and memory,
wherein the one or more computer programs include computer-executable instructions that, when executed by the one or more processors individually or collectively, cause the electronic device to:
detect a user selection of a first modality in the display,
detect at least one second modality present in vicinity to the first modality,
derive at least one pair of the first modality and the at least one second modality by correlating the first modality and the at least one second modality, and
provide a suggestion in a form of a user operable interface, based on the derived at least one pair, and
wherein a user operation on the suggestion initiates execution of the at least one action on the first modality via an application.

11. The electronic device as claimed in claim 10, wherein the first modality is selected from one of an image or a video frame from the display.

12. The electronic device as claimed in claim 11, wherein the one or more computer programs further include computer-executable instructions that, when executed by the one or more processors individually or collectively, cause the electronic device to:
receive one of the image or the video frame from the display,
divide the received one of the image or the video frame into a plurality of patches,
extract a patch embedding and a positional embedding from the plurality of patches, and
combine the extracted patch embedding and the positional embedding of the plurality of patches.

13. The electronic device as claimed in claim 10, wherein the first modality and the at least one second modality are detected using a machine learning (ML) technique.

14. The electronic device as claimed in claim 10, wherein the at least one second modality is detected in vicinity to the first modality using a layout learning model.

15. The electronic device as claimed in claim 10, wherein the at least one pair of the first modality and the at least one second modality comprises:
a pair of one or more textual elements, and
one or more non-textual elements.

16. The electronic device as claimed in claim 15, wherein the one or more computer programs further include computer-executable instructions that, when executed by the one or more processors individually or collectively, cause the electronic device to:
extract the one or more textual elements and the one or more non-textual elements from the first modality and the at least one second modality,
extract a positional embedding for each one of the first modality and the at least one second modality, and
combine the extracted one or more textual elements, the one or more non-textual elements, and positional embeddings of the first modality and the at least one second modality.

17. The electronic device as claimed in claim 16, wherein the one or more computer programs further include computer-executable instructions that, when executed by the one or more processors individually or collectively, cause the electronic device to:
combine the combined result of the extracted one or more textual elements, the one or more non-textual elements, and the positional embeddings of the first modality and the at least one second modality, and a combined result of a patch embedding and a positional embedding of a plurality of patches,
encode the combined result, and
derive the at least one pair of the first modality and the at least one second modality by encoding and decoding the combined result.

18. The electronic device as claimed in claim 10, wherein another user operation on the suggestion includes at least one of dismissing the suggestion or ignoring the suggestion.

19. One or more non-transitory computer-readable storage media storing one or more computer programs including computer-executable instructions that, when executed by one or more processors of an electronic device individually or collectively, cause the electronic device to perform operations for suggesting at least one action, the operations comprising:
detecting, by the electronic device, a user selection of a first modality in a display of the electronic device;
detecting, by the electronic device, at least one second modality present in vicinity to the first modality;
deriving, by the electronic device, at least one pair of the first modality and the at least one second modality by correlating the first modality and the at least one second modality; and
providing, by the electronic device, a suggestion in a form of a user operable interface, based on the derived at least one pair,
wherein a user operation on the suggestion initiates execution of the at least one action on the first modality via an application.

20. The one or more non-transitory computer-readable storage media of claim 19, the operations further comprising:
receiving, by the electronic device, one of an image or a video frame from the display of the electronic device;
dividing, by the electronic device, the received one of the image or the video frame into a plurality of patches;
extracting, by the electronic device, a patch embedding and a positional embedding from the plurality of patches; and
combining, by the electronic device, the extracted patch embedding and the positional embedding of the plurality of patches.
